(19) United States
(12) Patent Application Publication
(10) Pub. No.: US 2012/0254624 A1
(43) Pub. Date: Oct. 4, 2012

(54) THREE PARTY ATTESTATION OF UNTRUSTED SOFTWARE ON A ROBOT

(75) Inventors: Mushegh Malkhasyan, Redmond, WA (US); Gilbert Wong, Bellevue, WA (US); Brett Joseph Wedewer, Kirkland, WA (US); Lei Zhao, Issaquah, WA (US); Paul C. Roberts, Kirkland, WA (US)

(73) Assignee: Microsoft Corporation, Redmond, WA (US)

(21) Appl. No.: 13/075,176

(22) Filed: Mar. 29, 2011

(51) Int. Cl. G06F 11/30; G06F 12/14

(52) U.S. Cl. 713/189; 726/22

(57) ABSTRACT

Various technologies pertaining to three-party attestation of untrusted software on a robot are described herein. A robot includes trusted firmware, which includes read-only instructions. The robot also includes untrusted software. An attestation server is in communication with the robot by way of a network stack in the untrusted software. Messages are selectively transmitted amongst the firmware, the untrusted software, and the attestation server in connection with attesting to the untrusted software.

### BACKGROUND

Manufacturers of computing hardware that are designed and intended to execute a particular software stack generally desire to prohibit unauthorized software to be executed on the aforementioned hardware. In an example, manufacturers of certain mobile telephones have operating systems that are desirably execute thereon to provide a user with a particular user experience that is known to be associated with a particular mobile telephone. Accordingly, an aim of the manufacturer is to prohibit someone from undermining that user experience, for instance, by removing memory from the mobile telephone and replacing it with memory that is loaded with a different operating system (an operating system that is not intended to be executed on the mobile telephone). This jail breaking of the mobile telephone detracts from the user experience and may also interfere with a business model of the manufacturer of the mobile telephone. For example, such manufacturer may wish to monetize particular content that can be executed only by the operating system that is intended to execute on the mobile telephone. If unauthorized content or software is executing on the mobile telephone, this monetization of content may be extremely difficult or impossible.

Furthermore, it is desirable to detect when a computing device has been infected with malicious code, such as a virus, spyware, or the like. Conventionally, to prevent malicious code from being placed on a computing device, a user purchases and installs anti-virus software and executes such software on the computing device, which can consume a significant amount of computing resources. While this model has worked relatively effectively in the past, today users may have multiple computing devices, each of which may be in danger of receiving malicious code. For example, a user may have a desktop computer, a laptop computer, a mobile telephone, such as a smart phone, a gaming console, a Blu-Ray disc player or other suitable computing devices that are connected to a network and may therefore become infected with malicious code. It is inefficient and costly for a user to install and maintain antivirus packages on each of these computing devices.

### SUMMARY

The following is a brief summary of subject matter that is described in greater detail herein. This summary is not intended to be limiting as to the scope of the claims.

Various technologies pertaining to attesting to computer-executable code on computer-readable storage of a computing device are described herein. In an example, the computing device may be a robot that is packaged with a particular set of computer-executable instructions (e.g. packaged with a particular operating system). Various technologies are described herein that facilitate attesting that the computer executable code on the robot has been unaltered from a previous point in time, wherein the previous point in time can be a time of manufacture of the robot or a time corresponding to a most recent update of computer executable code on the robot that is authorized by the manufacture of the robot.

As will be described in greater detail herein, the attestation of the computer-executable code in the robot can be a three-party attestation, such that a remote server is utilized to attest to untrusted software on the robot. In an example, the robot can comprise firmware, wherein firmware is computer hardware with read-only instructions stored thereon. Additionally, the robot can comprise at least a portion of memory or hard drive that has untrusted software retained thereon. For example, an operating system of the robot can be retained in the aforementioned portions of memory and/or the hard drive. The untrusted software can include a network stack that can be employed in connection with transmitting and receiving data to and from an attestation server. The attestation server can attest to the untrusted software on the robot through utilization of a security protocol that will be described in greater detail herein.

The firmware can be loaded with instructions that cause attestation of the un-trusted software to be initiated. For instance, at boot up of the robot, periodically thereafter, or at random time intervals, the firmware can generate an attestation request and transmit such request to the untrusted software. The untrusted software may have a cached response that can be provided to the firmware. For instance, if the untrusted software was attested to within a threshold amount of time, the untrusted software can provide a cached response to the firmware. If, however, the untrusted software has not been attested to for a threshold amount of time, then a full attestation cycle can be initiated.

The untrusted software can transmit an attestation request to the attestation server through utilization of the network stack. The attestation request can include a first data packet, wherein the first data packet comprises data generated by the firmware of the robot. For instance, this data generated by the firmware can include a first random nonce. The attestation server can receive the attestation request and can generate a validation message based at least in part upon content of the data packet. This validation message can be transmitted back to the untrusted software, which can in turn communicate the validation message to the firmware. This validation message informs the firmware that the untrusted software has been attested to by the attestation server. The firmware may then allow the robot to operate with full functionality. If the attestation server does not provide the untrusted software with a validation message, then the firmware can cause the robot to operate with limited functionality. For example, the firmware can restrict movement of the robot.

Other aspects will be appreciated upon reading and understanding the attached figures and description.

### BRIEF DESCRIPTION OF THE DRAWINGS

FIG. 1 illustrates an exemplary robot.

FIG. 2 illustrates an operating environment illustrating communications between a robot and an attestation server.

FIG. 3 is a functional block diagram of an exemplary system that facilitates attestation of untrusted software residing on a robot.

FIG. 4 is a flow diagram that illustrates an exemplary methodology for attesting to untrusted software on a robot.

FIG. 5 is a flow diagram that illustrates an exemplary methodology for validating untrusted software residing on a robot.

FIG. 6 is a flow diagram that illustrates an exemplary methodology that facilitates validating software residing on robot.

FIG. 7 is a control flow diagram that illustrates communications between firmware and software on a robot and an attestation server in connection with attesting to untrusted software.

FIG. 8 is an exemplary computing system.

### DETAILED DESCRIPTION

Various technologies pertaining to attesting to computer-executable code executing on a computing device will now be described with reference to the drawings, where like reference numerals represent like elements throughout. In addition, several functional block diagrams of exemplary systems are illustrated and described herein for purposes of explanation; however, it is to be understood that functionality that is described as being carried out by certain system components may be performed by multiple components. Similarly, for instance, a component may be configured to perform functionality that is described as being carried out by multiple components. Additionally, as used herein, the term “exemplary” is intended to mean serving as an illustration or example of something, and is not intended to indicate a preference.

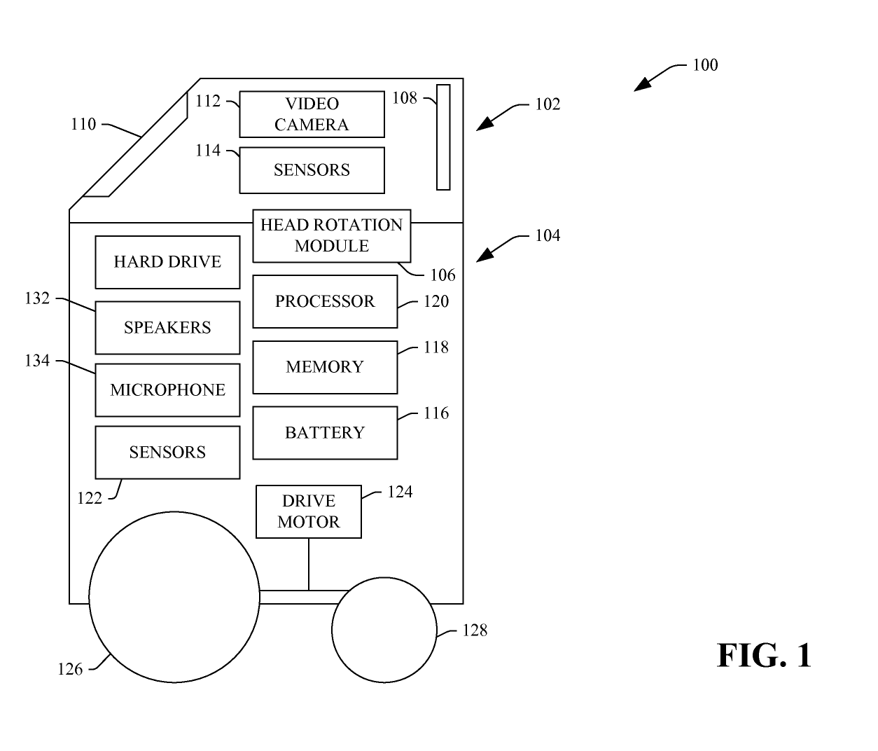

With reference to FIG. 1, an exemplary robot 100 that can communicate with a remotely located computing device by way of a network connection is illustrated. A “robot”, as the term will be used herein, is an electro-mechanical machine that includes computer hardware and software that causes the robot to perform functions independently and without assistance from a user. The robot 100 comprises a head portion 102 and a body portion 104, wherein the head portion 102 is movable with respect to the body portion 104. The robot 100 can comprise a head rotation module 106 that operates to couple the head portion 102 with the body portion 104, wherein the head rotation module 106 can include one or more motors that can cause the head portion 102 to rotate with respect to the body portion 104. Pursuant to an example, the head rotation module 106 can be utilized to rotate the head portion 102 with respect to the body portion 104 up to 45° in any direction. In another example, the head rotation module 106 can allow the head portion 102 to rotate 90° in relation to the body portion 104. In still yet another example, the head rotation module 106 can facilitate rotation of the head portion 102 180° with respect to the body portion 104. The head rotation module 106 can facilitate rotation of the head portion 102 with respect to the body portion 102 in either angular direction.

The head portion 102 may comprise an antenna 108 that is configured to receive and transmit wireless signals. For instance, the antenna 108 can be configured to receive and transmit Wi-Fi signals, Bluetooth signals, infrared (IR) signals, sonar signals, radio frequency (RF), signals or other suitable signals. In yet another example, the antenna 108 can be configured to receive and transmit data to and from a cellular tower. The robot 100 can send and receive communications with a remotely located computing device through utilization of the antenna 108. As will be described in greater detail below, the robot 100 can communicate with an attestation server through utilization of the antenna 108.

The head portion 102 of the robot 100 can also comprise a display 110 is that is configured to display data to an individual that is proximate to the robot 100. For example, the display 110 can be configured to display navigational status updates to a user. In another example, the display 110 can be configured to display images that are transmitted to the robot 100 by way of the remote computer. In still yet another example, the display 110 can be utilized to display images that are captured by one or more cameras that are resident upon the robot 100.

The head portion 102 of the robot 100 may also comprise a video camera 112 that is configured to capture video of an environment of the robot. In an example, the video camera 112 can be a high definition video camera that facilitates capturing video data that is in, for instance, 720p format, 720i format, 1080p format, 1080i format, or other suitable high definition video format. Additionally or alternatively, the video camera 112 can be configured to capture relatively low resolution data in a format that is suitable for transmission to the remote computing device by way of the antenna 108. As the video camera 112 is mounted in the head portion 102 of the robot 100 through utilization of the head rotation module 106, the video camera 112 can be configured to capture live video data of a relatively large portion of an environment of the robot 100.

The robot 100 may further comprise one or more sensors 114, wherein such sensors 114 may be or include any suitable sensor type that can aid the robot 100 in performing autonomous or semi-autonomous navigation. For example, these sensors 114 may comprise a depth sensor, an infrared sensor, a camera, a cliff sensor that is configured to detect a drop-off in elevation proximate to the robot 100, a GPS sensor, an accelerometer, a gyroscope, or other suitable sensor type.

The body portion 104 of the robot 100 may comprise a battery 116 that is operable to provide power to other modules in the robot 100. The battery 116 may be, for instance, a rechargeable battery. In such a case, the robot 100 may comprise an interface that allows the robot 100 to be coupled to a power source, such that the battery 116 can be relatively easily provided with an electric charge.

The body portion 104 of the robot 100 can also comprise a memory 118 and a corresponding processor 120. As will be described in greater detail below, the memory 118 can comprise a plurality of components that are executable by the processor 120, wherein execution of such components facilitates controlling one or more modules of the robot. The processor 120 can be in communication with other modules in the robot 100 by way of any suitable interface such as, for instance, a motherboard. It is to be understood that the processor 120 is the “brains” of the robot 100, and is utilized to process data received from the remote computing device, as well as other modules in the robot 100 to cause the robot 100 to perform in a manner that is desired by a user of such robot 100.

The body portion 104 of the robot 100 can further comprise one or more sensors 122, wherein such sensors 122 can include any suitable sensor that can output data that can be utilized in connection with autonomous or semi-autonomous navigation. For example, the sensors 122 may be or include sonar sensors, location sensors, infrared sensors, a camera, a cliff sensor, and/or the like. Data that is captured by the sensors 122 and the sensors 114 can be provided to the processor 120, which can process such data and autonomously navigate the robot 100 based at least in part upon data output by the sensors 114 and 122.

The body portion 104 of the robot 100 may further comprise a drive motor 124 that is operable to drive wheels 126 and/or 128 of the robot 100. For example, the wheel 126 can be a driving wheel while the wheel 128 can be a steering wheel that can act to pivot to change the orientation of the robot 100. Additionally, each of the wheels 126 and 128 can have a steering mechanism corresponding thereto, such that the wheels 126 and 128 can contribute to the change in orientation of the robot 100. Furthermore, while the drive motor 124 is shown as driving both of the wheels 126 and 128, it is to be understood that the drive motor 124 may drive only one of the wheels 126 or 128 while another drive motor can drive the other of the wheels 126 or 128. Upon receipt of data from the sensors 114 and 122 and/or receipt of commands from the remote computing device (received by way of the antenna 108), the processor 120 can transmit signals to the head rotation module 106 and/or the drive motor 124 to control orientation of the head portion 102 with respect to the body portion 104 of the robot 100 and/or orientation and position of the robot 100.

The body portion 104 of the robot 100 can further comprise speakers 132 and a microphone 134. Data captured by way of the microphone 134 can be transmitted to the remote computing device by way of the antenna 108. Accordingly, a user at the remote computing device can receive a real-time audio/video feed and can experience the environment of the robot 100. The speakers 132 can be employed to output audio data to one or more individuals that are proximate to the robot 100. This audio information can be a multimedia file that is retained in the memory 118 of the robot 100, audio files received by the robot 100 from the remote computing device by way of the antenna 108, real-time audio data from a web-cam or microphone at the remote computing device, etc.

While the robot 100 has been shown in a particular configuration and with particular modules included therein, it is to be understood that the robot can be configured in a variety of different manners, and these configurations are contemplated by the inventors and are intended to fall within the scope of the hereto-appended claims. For instance, the head rotation module 106 can be configured with a tilt motor so that the head portion 102 of the robot 100 can not only rotate with respect to the body portion 104 but can also tilt in a vertical direction. Alternatively, the robot 100 may not include two separate portions, but may include a single unified body, wherein the robot body can be turned to allow the capture of video data by way of the video camera 112. In still yet another exemplary embodiment, the robot 100 can have a unified body structure, but the video camera 112 can have a motor, such as a servomotor, associated therewith that allows the video camera 112 to alter position to obtain different views of an environment. Still further, modules that are shown to be in the body portion 104 can be placed in the head portion 102 of the robot 100, and vice versa. It is also to be understood that the robot 100 has been provided solely for the purposes of explanation and is not intended to be limiting as to the scope of the hereto-appended claims.

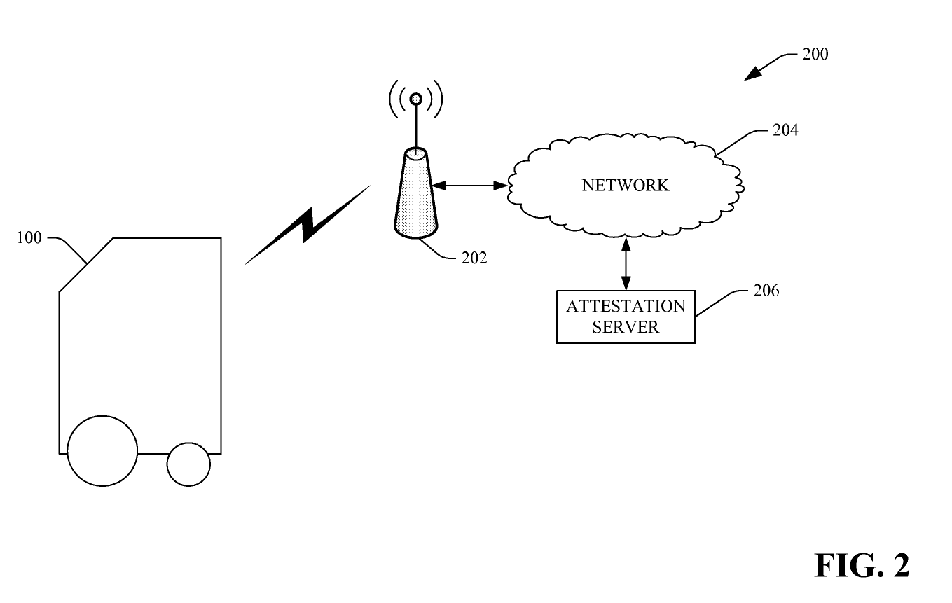

With reference now to FIG. 2, an exemplary environment 200 that facilitates communications between the robot 100 and an attestation server is illustrated. As described above, the robot 100 can comprise the antenna 108 that is configured to receive and transmit data wirelessly. In an exemplary embodiment, when the robot 100 is powered on, the robot 100 can communicate with a wireless access point 202 to establish its presence with such access point 202. The robot 100 may then obtain a connection to a network 204 by way of the access point 202. For instance, the network 204 may be a cellular network, the Internet, a proprietary network such as an intranet, or other suitable network.

The environment 200 further comprises an attestation server 206 that is configured to verify that contents on computer readable storage in the robot 100 have not been altered in an unauthorized manner. Such alteration may include installation of programs that are not approved by the manufacturer of the robot 100, installation of an operating system that is not desirably executed on the robot 100, existence of a computer virus on the robot 100 that causes certain files to be compromised or altered, etc. As will be described in greater detail below, the attestation server 206 can request a file digest of a randomly selected file that was known to be existent on the robot 100 at a previous point in time, wherein such file at the previous point in time is authorized by the manufacturer the robot 100. In an example, the previous point in time can be a time of manufacture of the robot 100 or a time of a software update that is approved by the manufacturer of the robot 100.

The attestation server 206 can transmit the request for the randomly selected file by way of the network 204, and such request can be delivered to the robot 100 by way of the access point 202. The request, for instance, can be in the form of a file path in a computer readable storage of the robot 100. The robot 100 can respond to this request with a file digest corresponding to the file that exists at the received file path. The file digest can be a hash of contents of the file, for example. In other words, the file digest can be a fingerprint that identifies the content of such file. The robot 100 can transmit the file digest back to the attestation server 206 by way of the access point 202 and the network 204. The attestation server 206 can compare the file digest received from the robot 100 with the file digest stored on the attestation server 206 that was known to correspond to the file at the previous point in time. If the received file digest matches the stored file digest, the attestation server 206 can transmit a validation message to the robot 100 by way of the network 204 and the access point 202. If, however, the file digest received from the robot 100 does not match the file digest retained at the attestation server 206, then the attestation server 206 can transmit a message that indicates that the content of the robot 100 has been altered in an unauthorized manner (or fail to transmit a validation message). This can cause the robot 100 to execute with limited functionality, wherein movement of the robot 100 can be limited or prohibited.

Additionally, a protocol will be described herein that facilitates prevention of replay attacks on communications between the robot 100 and the attestation server 206. This can be accomplished, for example, through utilization of multiple nonces: a first nonce generated at the robot 100 and a second nonce generated at the attestation server 206. During a loop back in the aforementioned protocol, the attestation server 206 can ensure that the robot 100 has replied with the nonce previously generated by the attestation server 206, and similarly the robot 100 can receive communication from the attestation server 206 and monitor such communications to ensure that the communications include the nonce previously generated by the robot 100. Again, this can facilitate prevention of malicious code from intercepting communications between the robot 100 and the attestation server 206 and employing replay attacks on the attestation server 206 and/or the robot 100.

While the attestation server 206 has been described above as retaining file digests corresponding to content of the robot, it is to be understood that cloud storage can retain the image of the content of the robot, and the attestation server 206 can request such image as needed. Thereafter, the attestation server 206 can compute file digests for files on the robot with, for instance, a hashing algorithm that is shared with the robot. Once validation is complete, the attestation server 206 can discard the computed file digests and/or content on the robot, and can retrieve such data from cloud storage as needed.

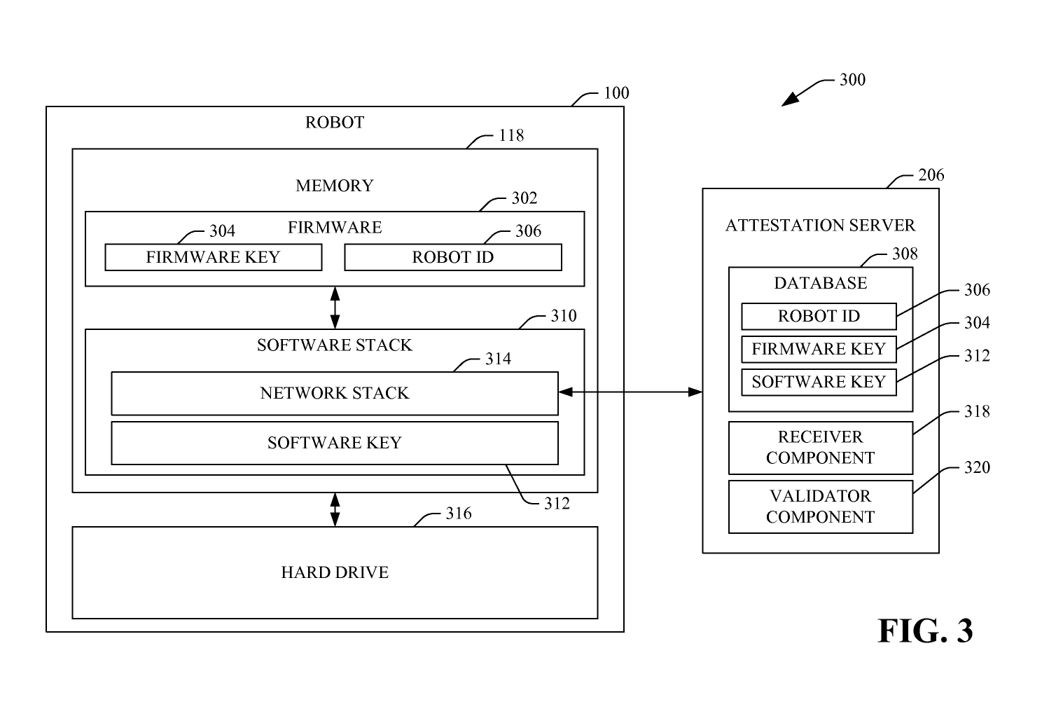

Now referring to FIG. 3, an exemplary system 300 that facilitates communication between the robot 100 and the attestation server 206 is illustrated. In this exemplary system 300, the robot 100 is shown as having a particular configuration with respect to computer readable storage thereon; it is to be understood, however, that other configurations are contemplated. As mentioned previously, the robot 100 comprises the memory 118. At least a portion of such memory 118 can be dedicated as firmware 302 at a time of manufacture of the robot 100. The firmware 302 in the robot can be a portion of the memory 118 that includes read-only instructions, such that content of the firmware 302 is unalterable by users of the robot 100. At a time of manufacture of the robot 100, a firmware key 304 can be established and retained in the firmware 302, wherein the firmware key 304 is a cryptographic key that can be utilized by the firmware 302 to encrypt messages generated by the firmware 302. For example, the firmware 302 can further include a cryptographic algorithm and can utilize the cryptographic firmware key 304 and the cryptographic algorithm to encrypt messages output by such firmware 302. Furthermore, the firmware 302 can comprise a robot identity 306 that identifies the robot 100 amongst other robots.

The memory 118 of the robot 100 may further comprise a software stack 310. It is to be understood that the software stack 310 is unable to read or modify the firmware key 302; rather, a highly secure portion of code in the firmware 302 is solely able to access the firmware key 302. The software stack 310 is untrusted software that comprises a plurality of computer executable instructions that facilitate causing the robot 100 to operate in a desired manner when such instructions are executed by the processor 120. For instance, portions of the software stack 310 can cause the robot 100 to operate in an autonomous manner. In another example, portions of the software stack 310 can cause a robot to operate in accordance with commands received from a user. It is thus to be understood that computer executable code in the software stack 310 can be utilized to process data received from the sensors 114 and 122, video from the video camera 112, and can control the modules described above with respect to FIG. 1 based at least in part upon such data.

The software stack 310 can include a software key 312, wherein the software key 312 is a cryptographic key that can be utilized to encrypt messages generated at the software stack 310. Accordingly, the software stack 310 may also comprise a cryptographic function that utilizes the software key 312 to encrypt data. The software key 312 can be included in the software stack 310 at the time of manufacture of the robot 100.

The software stack 310 may further comprising a network stack 314, wherein the network stack 314 comprises computer-executable code that facilitates transmitting and receiving data to and from the attestation server 206. As will be understood, the network stack 314 can comprise a set of protocols that are utilized in a communications network to transmit and receive data. In this exemplary embodiment, the firmware 302 does not include a network stack; thus, any messages generated the firmware 302 that are desirably transmitted to the attestation server 206 will pass through the software stack 310 (e.g., through the network stack 314). In other embodiments, however, the firmware 302 may include its own network stack.

The robot 100 may further comprise a hard drive 316. In an example, content of the hard drive 316 can be retained in cloud storage and/or at the attestation server 206, including user data. For the purposes of illustration, the firmware 302 and the software stack 310 have been shown to be entirely residing in the memory 118. It to be understood, however, that at least a portion of the firmware 302 and/or at least a portion of the software stack 310 can be placed in the hard drive 316 and loaded into the memory 118 as needed. Accordingly, at a time of manufacture the robot 100 and/or at a time when the software stack 310 is updated in an authorized manner, the hard drive 316 may include portions of the software stack 310 and/or portions of the firmware 302. Therefore, it is desirable to prevent an individual from removing the hard drive 316 and replacing such hard drive 316 with another hard drive loaded with different software (e.g., a different operating system).

The attestation server 206 as described above is in communication with the robot 100 by way of a network and can further be in communication with the manufacturing facility that manufactures the robot 100. The attestation server 206 can comprise a database 308, wherein the database 308 can include the firmware key 304, the robot identity 306, and the software key 312, which are also included in the firmware 302 and the software stack 310, respectively. The firmware key 304, the robot identity 306, and the software key 312 can be provided to the attestation server 206 by the manufacturing plant at the time of manufacture of the robot 100.

While the database 308 is shown as including the firmware key 304, the robot identity 306, and the software key 312, it is to be understood that the database 308 can include a significant amount of additional information pertaining to contents of the software stack 310. For example, at a time of manufacture of the robot 100, the manufacturing plant can provide the attestation server 206 with an image of content of the robot 100. Therefore, the database 308 in the attestation server 206 can additionally comprise a plurality of file paths that correspond to file paths in the software stack 310. The database 308 can further comprise file digests corresponding to the files at the file paths, wherein the file digests are indicative of content of the files in the software stack 310. For instance, a file digest may be a hash of content of a file. File digests that are retained in the database 308 can be computed at the attestation server 206 or can be pre-computed at the manufacturing plant and provided to the attestation server 206.

The attestation server 206 further comprises a receiver component 318. The attestation server 206 further comprises a validator component 320 that is in communication with the receiver component 318. The receiver component 318 and the validator component 320 can act in conjunction to attest to the untrusted software (the software stack 310) residing in the memory 118 and/or the hard drive 316 of the robot 100. Pursuant to an example, and as will be described below, the firmware 302 can initiate an attestation of the software stack 310. For example, the firmware 302 can generate an attestation request and can provide such attestation request to the software stack 310. The software stack 310 may then communicate the attestation request to the attestation server 206, wherein the attestation request is received by the receiver component 318. In an example, the attestation request can be in the form of a first data packet. The receiver component 318 receives the first data packet from the software stack 310. As mentioned previously, the first data packet comprises data generated by the firmware 302. The validator component 320 can transmit a validation message back to the software stack 310, wherein the validation message indicates to the firmware 302 that the untrusted software on the robot 100 is authorized to reside on such robot 100.

As mentioned above, the database 308 can include a plurality of file paths that correspond to known authorized files on the robot 100 (in the software stack 310 of the robot 100). Pursuant to an example, when the attestation server 206 receives the attestation request from the robot 100, the validator component 320 can randomly select one of the file paths from the database 308 and can cause such selected file path to be transmitted back to the robot 100. The software stack 310 can receive the randomly selected file path and can access the file in the software stack 310 that is at the file path. The software stack 310 may then compute a file digest for the file at the randomly selected location and can cause this file digests to be transmitted back to the attestation server 206, wherein the receiver component 318 receives such file digest. The validator component 320 may then compare the file digest received from the robot 100 with a file digest in the database 308 that corresponds to the randomly selected file path. The validator component 320 may then cause the validation message to be transmitted back to the robot 100 so long as the file digest received from the robot 100 and the file digest in the database 308 match.

Moreover, a plurality of random nonces can be utilized in connection with preventing replay attacks. Pursuant to an example, the firmware 302 can generate a first random nonce when initially requesting attestation of the software stack 310. This first random nonce can be transmitted to the attestation server 206, wherein the receiver component 318 receives the nonce. For example, the first random not nonce can be a portion of the attestation request. The receiver component 318 can cause the first random nonce to be stored in the database 308 of the attestation server 206. The validator component 320 may then cause a second random nonce to be generated and transmitted to the robot 100 together with, for instance, the full file path mentioned previously. This data can be received by the software stack 310 and transmitted to the firmware 302, wherein the firmware 302 can retain the second random nonce or cause the second random nonce to be retained in the memory 118. When the software stack 310 provides the file digests to the attestation server 206, the software stack 310 can also provide the second random nonce. The receiver component 318 can receive the second random nonce, and the validator component 320 can compare the second random nonce with the previously transmitted second random nonce to ensure that a replay attack has not occurred. When the validator component 320 transmits a validation message, such message can further comprise the first random nonce that was previously generated by the firmware 302. Prior to the firmware 302 outputting a command that allows the software stack 310 to continue executing on the robot 100, the firmware 302 can compare the nonce receipt from the attestation server 206 with the first random nonce previously generated by the firmware 302. Utilization of these two nonces in a replay loop of the protocol facilitates prevention of replay attacks.

Furthermore, for each data packet that is transmitted to the attestation server 206, both the firmware 302 and the software stack 310 can encrypt at least a portion of such data packet through utilization of the firmware key 304 and the software key 312, respectively. The attestation server 206 may then utilize the firmware key 304 and the software key 312 retained in a database 308 to decrypt such data packet. Moreover for data desirably transmitted from the attestation server 206 to the software stack 310 and the firmware 302, the validator component 320 can appropriately encrypt such data with the firmware key 304 and the software key 312, respectively. For example, the validator component 320 can encrypt data that is desirably received only by the software stack 310 with the software key 312, but can decrypt data that is first received by the software stack 310 and thereafter desirably received by the firmware 302 through utilization of both the software key 312 and the firmware key 304.

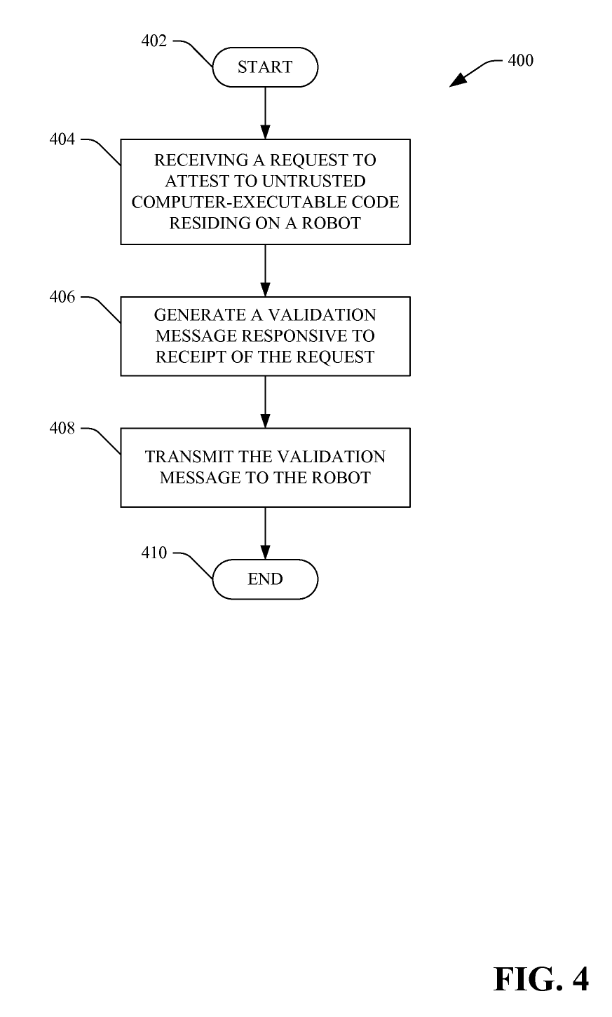

With reference now to FIGS. 4-7, various exemplary methodologies and a control flow are illustrated and described. While the methodologies and control flow are described as being a series of acts that are performed in a sequence, it is to be understood that the methodologies and control flow are not limited by the order of the sequence. For instance, some acts may occur in a different order than what is described herein. In addition, an act may occur concurrently with another act. Furthermore, in some instances, not all acts may be required to implement a methodology or control flow described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like. The computer-readable medium may be a non-transitory medium, such as memory, hard drive, CD, DVD, flash drive, or the like.

Referring now to FIG. 4, an exemplary methodology 400 that facilitates attesting to untrusted software residing on computer hardware of a robot is illustrated. In an example the methodology 400 can be configured for execution by the attestation server 206. The methodology 400 starts at 402, and a 404 a request to attest to the untrusted computer executable code residing on hardware of the robot is received, wherein the request is received from the untrusted computer executable code, and wherein the request comprises first data generated by firmware on the robot and second data generated by the untrusted computer executable code. As described above, the firmware comprises computer hardware and read-only instructions. Pursuant to an example, the first data generated by the firmware on the robot can comprise a first random nonce and the second data generated by the untrusted computer executable code can comprise for instance, an identity of the robot.

At 406, a validation message is generated based at least in part upon the first data generated by the firmware on the robot and the second data generated by the untrusted computer executable code. At 408, the validation message is transmitted to be untrusted computer executable code that resides on the robot. The methodology completes that 410.

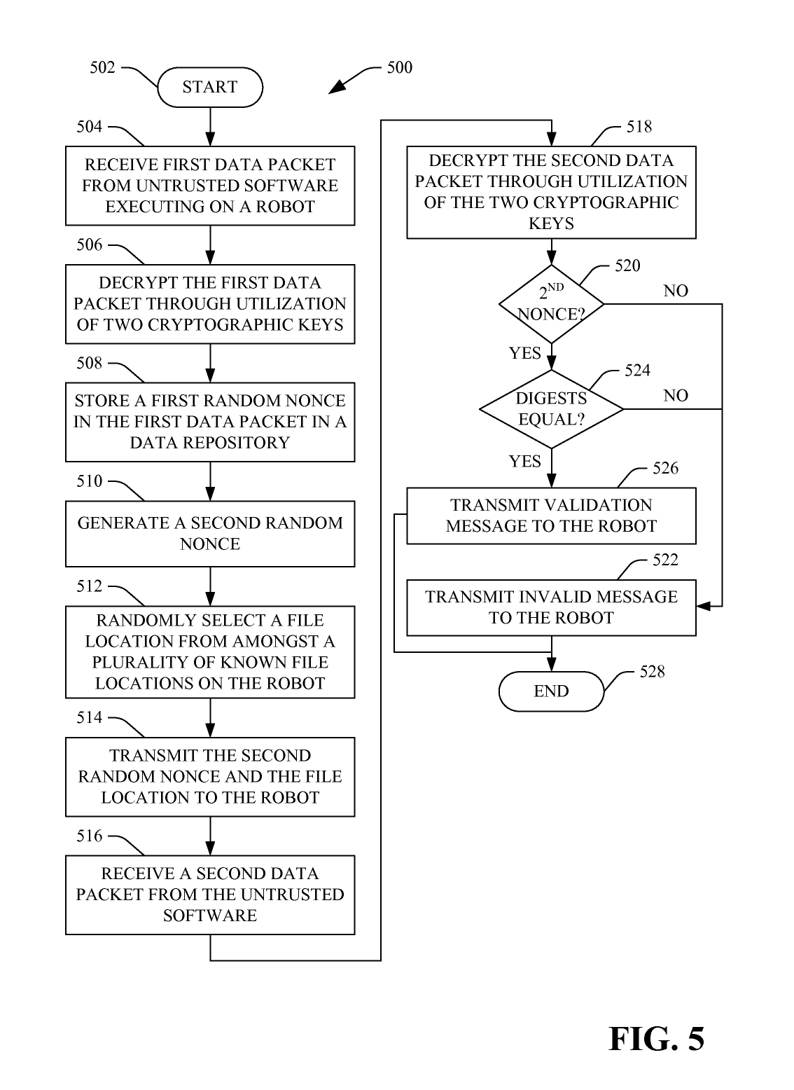

With reference now to FIG. 5, an exemplary methodology 500 that facilitates attesting to untrusted software residing on a robot is illustrated. The methodology 500 starts at 502, and 504 a first data packet is received from untrusted software that resides on a robot. Pursuant to an example, the first data packet can include a first random nonce generated by firmware on the robot. The first data packet can further comprise an identity of the robot that is included in the first data packet by the untrusted software. Furthermore, at least a portion of the first data packet is encrypted by the firmware through utilization of a first cryptographic key (the firmware key) and the at least portion of the first data packet is further encrypted by the untrusted software through utilization of a second cryptographic key (the software key). Thus, the firmware and untrusted software can have access to a cryptographic function that encrypts data through utilization of a cryptographic key. Additionally, data that is generated at the firmware can be encrypted by both the first cryptographic key and the second cryptographic key while data generated by the untrusted software may be encrypted through utilization of only the second cryptographic key.

At 506, the first data packet is decrypted through utilization of the two cryptographic keys. At 508, the first random nonce is stored in a data repository. As will be described below, the first random nonce can be transmitted back to the robot 100 in subsequent communications with the robot 100 to prevent replay attacks.

At 510, a second random nonce is generated. At 512, a file path from amongst a plurality of known file paths on the robot is randomly selected from the data repository. The randomly selected file path corresponds to a file residing on the robot. In addition, the data repository further comprises a first file digests that is indicative of the content of the known file on the robot. For example, the file digest can be a hash of the content of the file.

At 514, the second random nonce and the file path are transmitted to the robot. In an example, the second random nonce and the file path can be encrypted through utilization of one or more of the first cryptographic key or the second cryptographic key.

At 516, a second data packet is received from the untrusted software. The second data packet includes a second file digest that is indicative of contents of the file at the file path on the robot. In other words, the robot has accessed the file at the file path provided thereto by the attestation server, and has generated a file digest of such file. The robot then transmits this file digests back to the attestation server. Additionally, the second data packet further comprises the second random nonce. Moreover, at least a portion of the second data packet is encrypted by both of the first cryptographic key and the second cryptographic key.

At 518, the second data packet is decrypted through utilization of the first cryptographic key and the second cryptographic key. At 520, a determination is made that the nonce in the second data packet is equivalent to the nonce transmitted to the robot at 514. If the second data packet does not comprise the nonce transmitted to the robot at 514, then the methodology 500 proceeds to 522, where a message is transmitted to the robot that indicates that the untrusted software has been altered in an unauthorized manner. If at 520, however, it is determined that the second data packet comprises the nonce transmitted to the robot 514, then at 524 a determination is made regarding whether the file digests transmitted to the robot 514 is equivalent to the file digest received from the robot at 516. If the file digests are not equal, then at 522 the message that indicates that the untrusted software has been changed and in an unauthorized manner is transmitted robot. If the digests are found to be equal, then at 526 a validation message is transmitted to the robot. At this point, the robot can continue to operate with full functionality. The methodology 500 completes at 528.

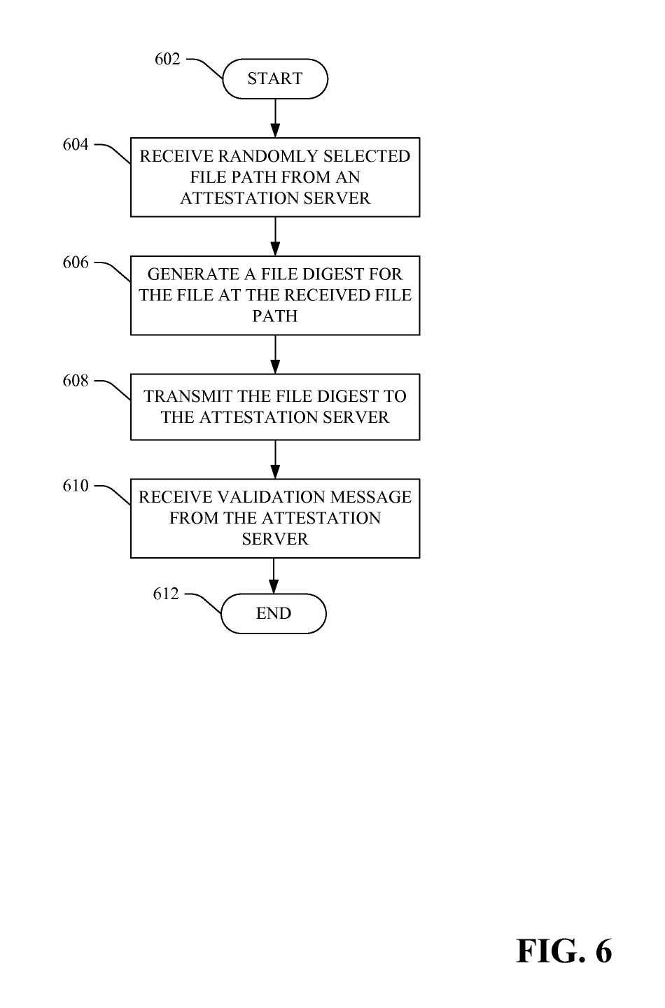

Now referring to FIG. 6, an exemplary methodology 600 that facilitates attesting to untrusted software residing on a robot is illustrated. In an example, the methodology 600 may be configured for execution on the robot. The methodology 600 starts at 602, at 604 a randomly selected file path is received from an attestation server. At 606, a file at the randomly selected file path is accessed, and a file digest is generated for such file.

At 608, the file digest is transmitted to the attestation server, wherein such file digest can be compared with a file digest that is known to have corresponded to the filed a previous point in time. At 610, a validation message is received from the attestation server such that the robot can continue to operate with full functionality. The methodology 600 completes at 612.

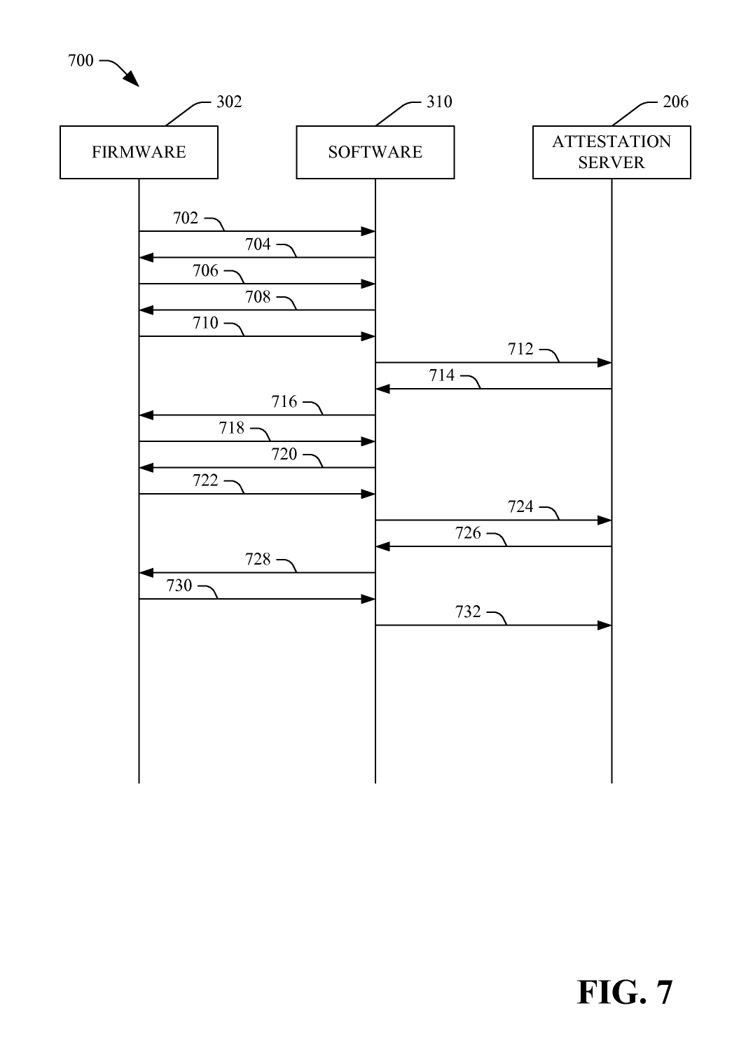

With reference now to FIG. 7, an exemplary control flow diagram 700 that illustrates attestation of contents of the software stack 310 on the robot 100 is illustrated. The exemplary control flow diagram 700 corresponds with the architecture of the robot 100 described in connection with FIG. 3, wherein the memory 118 of the robot 100 comprises the firmware 302 and the software stack 310, and wherein the software stack 310 comprises the network stack 314, such that communication to the attestation server 206 is through the software stack 310. As mentioned previously, during manufacture of the robot 100, certain information is shared between the firmware 302 and the attestation server 206 and the software stack 310 and the attestation server 206. Specifically, the firmware 302 includes the firmware key 304 and the robot identity 306, and the attestation server 206 also includes the firmware key 304 and the robot identity 306. Moreover, the software stack 310 includes the software key 312, which is also included in the attestation server 206.

Furthermore, the attestation server 206 can comprise an image of contents of the software stack 310, wherein said image can be updated, for instance, each time an authorized update is made to the software stack 310. Additionally or alternatively, the attestation server 206 can comprise a plurality of file digests corresponding to the plurality of files in the software stack 310, and can also comprise file paths to such files. This information can be indexed on the attestation server 206, for example, by the robot identity 306.

At 702, computer executable instructions resident on the firmware 302 generate an attestation request. For example, computer executable instructions on the firmware 302 can be configured to cause the robot 100 to operate with limited functionality if the software stack 310 is not attested to by the attestation server 206 at boot up time or within specific amounts of time. The software stack 310 (which can comprise operating system of the robot 100) receives the attestation request from the firmware 302, and determines whether a cached response is sufficient to satisfy the attestation request. For example, if the attestation server 206 has recently attested to contents of the software stack 310, then at 704 the software stack 310 can respond to the attestation request with a cached response. Such cached response may be a validation message that was previously transmitted to the software stack 310 by the attestation server 206. The firmware 302 can analyze the cached response to determine if such cached response is valid (if it has a time stamp corresponding to a relatively recent point in time). If the cached response is invalid, or at boot up of the robot 100, the firmware 302 can generate a full attestation cycle request. In other words, at 706 the firmware 302 can inform the software stack 310 that an updated validation message is desirably received from the attestation server 206.

At 708, the software stack 310 transmits a request to the firmware 302 to generate a first nonce, wherein the first nonce comprises a plurality of randomly generated digits. Responsive to receiving such request, the firmware 302 can generate the first nonce. Optionally, the firmware 302 can append a timestamp to the first nonce and can further add a data packet that acts as a sentinel to the first nonce. Furthermore, the firmware 302 can encrypt the resulting data packet (the nonce, the timestamp and the sentinel) with the firmware key 304. The combination of the nonce, the timestamp and the sentinel can be collectively referred to as the first nonce, and the firmware 302 can utilize the firmware key 304 to encrypt the first nonce. At 710, the firmware 302 can transmit the encrypted first nonce to the software stack 310.

The software stack 310 may then further encrypt the first nonce through utilization of the software key 312. Moreover, optionally, the software stack 310 can add the robot identity 306 to the data packet and further encrypt such data packet with a public key that corresponds to the attestation server 206.

At 712, this data packet is transmitted to the attestation server 206. Upon receipt thereof, the attestation server decrypts the data packet using, for instance, a private key of the attestation server 206, the firmware key, and the software key. The attestation server 206 may then retain the first nonce generated by the firmware 302 in data storage. The data transmitted to the attestation server 206 at 712 can be referred to as an attestation request received at the attestation server 206. Responsive to such request, the attestation server 206 can generate a second nonce and can further randomly select a file path that corresponds to a file on the robot 100. As mentioned previously, the attestation server 206 comprises a database with a number of file paths and corresponding file digests. The attestation server 206 can randomly select a file path for transmission to the robot 100 to verify that contents of the software stack 310 have not been altered in an unauthorized manner. The attestation server 206 can further encrypt this nonce and the full file path utilizing the software key 312 and the firmware key 304 (and optionally a private key on the attestation server 206 that corresponds to a public key). At 714, the attestation server 206 can transmit the encrypted second nonce and full file path to the software stack 310. The software stack 310 may then decrypt the data through utilization of the software key 312. At 716, the software stack 310 transmits the partially decrypted nonce and full file path to the firmware 302, which can further decrypt the data packet utilizing the firmware key 304. The firmware 302 can cause the second nonce to be retained in computer readable storage at the robot 100.

At 718, the firmware 302 causes the full file path to be transmitted to the software stack 310. The software stack 310 accesses the file that corresponds to the full file path and generates a file digest for such file. At 720, the software stack 310 transmits the file digest corresponding to the full file path to the firmware 302. The firmware 302, responsive to receipt of the file digest, can generate a cryptographic challenge. Such cryptographic challenge, for instance, can include an encryption of the file digest, the robot identity 306, a particular challenge command, a timestamp, and the second nonce generated by the attestation server 206. Moreover, the firmware 302 can encrypt the challenge utilizing the firmware key 304. The encrypted challenge can be transmitted to the software stack 310 at 722. The software stack 310 may then further encrypt the challenge utilizing the software key 312. Additionally, the software stack 310 can add the robot identity 306 to the challenge and further encrypt the data utilizing the public key of the attestation server 206.

The software stack 310 then transmits this encrypted challenge to the attestation server 206 at 724. Thereafter, the attestation server 206 decrypts the challenge utilizing the private key of the attestation server 206, the software key 312 and the firmware key 304. The attestation server 206 can utilize the robot identity 306 included in the challenge to locate the appropriate file digest in the database. The attestation server 206 can compare the timestamp included in the received challenge with a current time to ensure that the challenge has been transmitted within a threshold amount of time. The attestation server 206 can further check the nonce included in the challenge to ensure that the nonce matches the nonce that was previously transmitted by the attestation server 206. Moreover, the attestation server 206 compares the file digest received in the challenge with the file digest retained in the database at the attestation server 206. If the attestation server 206 determines that the attestation challenge was transmitted within a threshold amount of time, that the nonce included in the challenge matches the second nonce generated by the attestation server 206, and that the file digest matches the file digest in the database, then the attestation server 206 can generate a validation message for transmittal to the software stack 310. The attestation server 206 can encrypt this validation message, for example, with the software key and the firmware key. Additionally, the attestation server 206 can include the first nonce (generated by the firmware 302) in the validation response. The attestation server 206 may transmit the validation response to the software stack 310 at 726.

The software stack 310 may then decrypt the validation response utilizing the software key 312 and can transmit the remainder of the data to the firmware 302 at 728. The firmware 302 can analyze a timestamp corresponding to the validation message to ensure that the validation response has been received within a threshold amount of time from the challenge request and can compare the nonce in the validation request with the nonce previously generated by the firmware 302. If the nonces match, and the message includes a validation message, and a timestamp in the validation message is within the threshold amount of time, then at 730 the firmware 302 can transmit a message to the software stack 310 indicating that attestation has completed. At 732, the software stack 310 can transmit a message to the attestation server 206 indicating that the attestation has completed and the transaction is closed. If the firmware 302 determines that the nonce in the validation message does not match the previously generated nonce, or ascertains that the message indicates that attestation has failed, then the firmware 302 can effectively cause the robot 100 to operate with limited functionality.

While the systems, methods and control flow diagram described above have been described with respect to robots, it is to be understood that various other devices that include computing technology can utilize aspects described herein. For instance, industrial automation equipment includes various moving parts, and may be controlled at least in part through utilization of software. One or more of the methods described herein pertaining to ensuring that the software utilized to control this industrial automation machinery is valid can be employed. Still further, automobiles are being configured to perform some automated driving tasks, such as parallel parking Again, this can be controlled by software executing on a computing device included in the automobile. The methods described herein can be utilized in connection with ensuring that the software executing on the automobile is valid to ensure that the automobile will operate as expected or desired by the manufacturer and operator. Still further, the systems and methods utilized herein may be employed in conventional computing devices such as desktop computers, gaming consoles, laptop computers, mobile telephones, mobile media players, DVD players, amongst other computing devices.

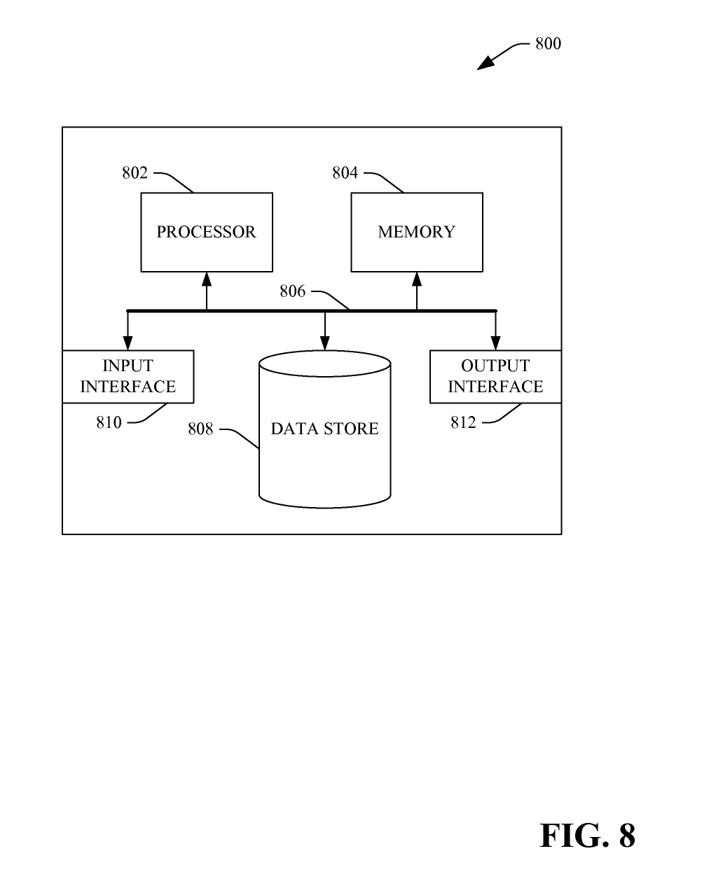

Now referring to FIG. 8, a high-level illustration of an exemplary computing device 800 that can be used in accordance with the systems and methodologies disclosed herein is illustrated. For instance, the computing device 800 may included in the attestation server 206 or the robot 100. In any event, the computing device 800 can be used in a system that supports attesting to computer-executable code on a robot. The computing device 800 includes at least one processor 802 that executes instructions that are stored in a memory 804. The memory 804 may be or include RAM, ROM, EEPROM, Flash memory, or other suitable memory. The instructions may be, for instance, instructions for implementing functionality described as being carried out by one or more components discussed above or instructions for implementing one or more of the methods described above. The processor 802 may access the memory 804 by way of a system bus 806. In addition to storing executable instructions, the memory 804 may also store cryptographic keys, nonces, file digests, etc.

The computing device 800 additionally includes a data store 808 that is accessible by the processor 802 by way of the system bus 806. The data store 808 may be or include any suitable computer-readable storage, including a hard disk, memory, etc. The data store 808 may include executable instructions, cryptographic keys, nonces, file digests, file paths, etc. The computing device 800 also includes an input interface 810 that allows external devices to communicate with the computing device 800. For instance, the input interface 810 may be used to receive instructions from an external computer device, a user, etc. The computing device 800 also includes an output interface 812 that interfaces the computing device 800 with one or more external devices. For example, the computing device 800 may display text, images, etc. by way of the output interface 812.

Additionally, while illustrated as a single system, it is to be understood that the computing device 800 may be a distributed system. Thus, for instance, several devices may be in communication by way of a network connection and may collectively perform tasks described as being performed by the computing device 800.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices. Furthermore, a component or system may refer to a portion of memory and/or a series of transistors.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method, comprising:
receiving, from untrusted computer-executable code executing on a robot, a request to attest to the untrusted computer-executable code executing on the robot, wherein the request comprises first data generated by firmware on the robot and second data generated by the untrusted computer-executable code, wherein the firmware comprises hardware and read-only instructions; and
generating a validation message based at least in part upon the first data generated by the firmware on the robot and the second data generated by the untrusted computer-executable code; and
transmitting the validation message to the untrusted computer-executable code executing on the robot.

2. The method of 1, wherein the request is received by way of the Internet.

3. The method of claim 1, wherein the first data generated by the firmware on the robot comprises a first nonce, wherein the first nonce comprises a first plurality of randomly generated digits.

4. The method of claim 3, wherein the validation message comprises the first nonce.

5. The method of claim 4, further comprising:
prior to transmitting the validation message, generating a second nonce, wherein the second nonce comprises a second plurality of randomly selected digits;
transmitting the second nonce to the untrusted computer-executable code executing on the robot;
subsequent to transmitting the second nonce to the untrusted computer-executable code executing on the robot, receiving the second nonce from the untrusted computer-executable code executing on the robot, wherein the validation message is generated subsequent to receiving the second nonce from then untrusted computer-executable code executing on the robot.

6. The method of claim 1 configured for execution on an attestation server that is in communication with the robot by way of a network connection.

7. The method of claim 1, wherein the request is encrypted by a first cryptographic key that resides in the firmware and a second cryptographic key that is accessible to the untrusted computer-executable code, and wherein the method further comprises:
decrypting the request through utilization of the first cryptographic key and the second cryptographic key.

8. The method of claim 1, further comprising:
prior to generating the validation message, randomly selecting a first file location on the robot from amongst a plurality of known, valid file locations, wherein a first file digest that is indicative of content of a first valid file at the first file location on the robot is known;
transmitting the first file location to the untrusted computer-executable code executing on the robot;
subsequent to transmitting the first file location, receiving a second file digest from the untrusted computer-executable code executing on the robot, wherein the second file digest is indicative of content of the first valid file at the first location on the robot;
comparing the first file digest with the second file digest to ensure that first file digest is equivalent to the second file digest; and
generating the validation message based at least in part upon the first file digest and the second file digest being equivalent.

9. The method of claim 8, further comprising prior to receiving the request to attest to the untrusted computer-executable code executing on the robot, receiving the plurality of known, valid file locations on the robot and a corresponding plurality of file digests that are indicative of content of files on the robot that correspond to the plurality of file locations.

10. The method of claim 9, wherein the plurality of known, valid file locations on the robot are received at a time of manufacture of the robot.

11. The method of claim 9, wherein the plurality of known, valid file locations on the robot are received at a time corresponding to a valid update of content on the robot.

12. A system that supports three-party attestation of untrusted software executing on a robot, the system comprising:
a receiver component that receives a first data packet, wherein the first data packet is received from the untrusted software executing on the robot, and wherein the first data packet comprises data generated by firmware of the robot, wherein the firmware comprises computer hardware and read-only instructions; and
a validator component that transmits a validation message to the untrusted software executing on the robot, wherein the validation message indicates to the firmware that the untrusted software executing on the robot is authorized to execute on the robot.

13. The system of claim 12 comprised by an attestation server that is in communication with the robot by way of the Internet.

14. The system of claim 12, further comprising:
a data repository that comprises:
a plurality of file locations on the robot that correspond to known, valid files on the robot at a first point in time; and
a plurality of file digests that are indicative of content of the known, valid files on the robot at the first point in time, wherein the validator component randomly selects a file location from amongst the plurality of file locations and transmits the file location to the untrusted software executing on the robot, wherein the receiver component receives from the untrusted software executing on the robot a first file digest that is indicative of content of a first file at the file location on the robot, and wherein the validator component compares the first file digest with a file digest in the data repository that corresponds to the file location and transmits the validation message based at least in part upon the first file digest and the file digest in the data repository being equivalent.

15. The system of claim 12, wherein the receiver component additionally receives a first nonce that is generated by the firmware on the robot, wherein the first nonce comprises a first plurality of randomly generated digits, and wherein the validation message transmitted by the validator component comprises the first nonce.

16. The system of claim 15, wherein prior to transmitting the validation message, the validator component generates a second nonce and transmits the second nonce to the untrusted software executing on the robot, and wherein subsequent to transmitting the second nonce, the receiver component receives the second nonce from the untrusted software, and wherein the validator component transmits the validation message based at least in part upon receipt of the second nonce.

17. The system of claim 12, wherein at least a portion of the first data packet is encrypted by the firmware through utilization of a first cryptographic key, and wherein at least the portion of the first data packet is further encrypted by the untrusted software through utilization of the second cryptographic key, and wherein the receiver component decrypts the at least the portion of the first data packet through utilization of the first cryptographic key and the second cryptographic key.

18. The system of claim 17, further comprising a data repository, wherein the data repository comprises the first cryptographic key and the second cryptographic key, and wherein the receiver component receives the first cryptographic key and the second cryptographic key from a facility that manufactures the robot.

19. The system of claim 12, wherein the robot is an industrial automation device.

20. A non-transitory computer-readable medium comprising instructions that, when executed by a processor, cause the processor to perform acts comprising:
receiving a first data packet from untrusted software executing on a robot, wherein the first data packet comprises a first random nonce generated by firmware on the robot, wherein the firmware comprises computer-hardware and read-only instructions, wherein the first data packet further comprises an identity of the robot included by the untrusted software, and wherein at least a portion of the first data packet is encrypted by the firmware through utilization of a first cryptographic key and the at least portion of the first data packet is further encrypted by the untrusted software through utilization of a second cryptographic key;
decrypting the first data packet through utilization of the first cryptographic key and the second cryptographic key;
storing the first random nonce in a data repository;
generating a second random nonce;
randomly selecting a file location from amongst a plurality of file locations from the data repository, wherein the file location corresponds to a known file on the robot, and wherein the data repository further comprises a first file digest that is indicative of the content of the known file on the robot;
transmitting the second random nonce and the file location to the untrusted software executing on the robot;
receiving a second data packet from the untrusted software executing on the robot, wherein the second data packet comprises a second file digest that is indicative of contents of the file at the file location on the robot, wherein the second data packet further comprises the second random nonce, and wherein at least a portion of the second data packet is encrypted by the firmware through utilization of the first cryptographic key and is further encrypted by the untrusted software through utilization of the second cryptographic key;
decrypting the at least the portion of the second data packet through utilization of the first cryptographic key and the second cryptographic key;
ensuring that the second data packet comprises the second random nonce;
comparing the first file digest with the second file digest to ensure that the first file digest is equivalent to the second file digest; and
transmitting a validation message to the untrusted software that indicates that the untrusted software is authorized to execute on the robot, wherein the validation message comprises the first random nonce.
